(19) United States
(12) Patent Application Publication
(10) Pub. No.: US 2011/0181920 A1
(43) Pub. Date: Jul. 28, 2011

(54) IMAGE READING APPARATUS AND CONTROL METHOD THEREOF

(76) Inventor: Won Taek Kim, Suwon-si (KR)

(21) Appl. No.: 12/979,452

(22) Filed: Dec. 28, 2010

(30) Foreign Application Priority Data
Dec. 28, 2009 (KR) 10-2009-131593

(51) Int. Cl. H04N 1/04

(52) U.S. Cl. 358/474

(57) ABSTRACT

An image reading apparatus and a control method thereof, which enable accurate determination of a document size. The image reading apparatus includes a cover provided with a mark pattern having a preset length to sense a width of a document, a light source to irradiate light to a region where the mark pattern is formed, an image sensor to produce an image upon receiving the light reflected from the region where the mark pattern is formed, and a controller to determine the width of the document based on a length of a region of the produced image where a constant pixel value is sensed.

### CROSS-REFERENCE TO RELATED APPLICATIONS

This application claims priority under 35 U.S.C. §119 from Korean Patent Application No. 2009-0131593, filed on Dec. 28, 2009 in the Korean Intellectual Property Office, the disclosure of which is incorporated herein in its entirety by reference.

### BACKGROUND

1. Field of the Invention

Embodiments of the present general inventive concept relate to an image reading apparatus which may automatically sense the size of a document and a control method thereof.

2. Description of the Related Art

An image reading apparatus is devised to read an image recorded on a paper document via scanning, thus acquiring information included in the document, such as a picture or a figure. Examples of image processing apparatuses include scanners, fax-machines, devices combining functions thereof, translating machines, Computer Aided Design (CAD) systems, character recognizers, and digital copiers.

Image reading apparatuses adopt a flat bed scanning method or a sheet feed scanning method. The flat bed scanning method scans a stationary document by moving a scanning module. Similar to a general copier, a sheet of paper is put on a flat glass panel and a scanning module is horizontally moved to scan the sheet of paper.

Generally, a flat bed scanning type image reading apparatus includes a plurality of document sensors arranged at specific positions with respect to a document platen. When a document to be copied is put on a document platen and then a platen cover is closed, the document sensors generate signals informing of whether or not the document is present thereon. Accordingly, it may be possible to determine the length and width of the document based on the signals from the document sensors.

However, use of the plurality of document sensors to determine document size may increase manufacturing costs of the image reading apparatus.

### SUMMARY

The present general inventive concept provides an image reading apparatus, in which a mark pattern to sense the width of a document is used, enabling reduction in the number of sensors to sense the document width, and a control method thereof.

Exemplary embodiments and utilities of the present general inventive concept will be set forth in part in the description which follows and, in part, will be obvious from the description, or may be learned by practice of the present general inventive concept.

In accordance with embodiments and utilities of the present general inventive concept, an image reading apparatus includes a cover provided with a mark pattern having a preset length to sense a width of a document, a light source to irradiate light to a region where the mark pattern is formed, an image sensor to produce an image upon receiving the light reflected from the region where the mark pattern is formed, and a controller to determine the width of the document based on a length of a region of the produced image where a constant pixel value is sensed.

The mark pattern may include two marks having different colors alternately arranged at a preset interval in a main-scanning direction.

The mark pattern may be formed at a document push plate provided to push the document when the cover is closed.

The mark pattern may be formed at a region of the document push plate corresponding to a front end of the document.

The image reading apparatus may further include a cover sensing device to sense closing of the cover, and the controller may turn on the light source to allow the image sensor to produce the image when closing of the cover is sensed by the cover sensing device.

The image reading apparatus may further include a document sensor arranged below a document platen, on which the document is placed, to sense the presence of the document, and the controller may determine a length of the document according to a presence of the document.

The controller may determine document size according to the width and length of the document.

In accordance with utilities and embodiments of the present general inventive concept, an image reading apparatus includes a cover provided with a mark pattern having a preset length to sense a width of a document, a light source to irradiate light to a region where the mark pattern is formed, an image sensor to produce an image upon receiving the light reflected from the region where the mark pattern is formed, a cover sensing device to sense closing of the cover, and a controller to allow the image to be produced when closing of the cover is sensed by the cover sensing device, and to determine the width of the document according to a length of a region of the produced image where a constant pixel value is sensed.

The mark pattern may include two marks having different colors alternately arranged at a preset interval in a main-scanning direction in a region of the cover corresponding to a front end of the document.

The image reading apparatus may further include a drive motor to move the light source in a sub-scanning direction, and the drive motor may move the light source to a position corresponding to the region where the mark pattern is formed when the cover is closed, to allow the image to be produced when the cover is closed.

The image reading apparatus may further include a document sensor arranged below a document platen, on which the document is placed, to sense a presence of the document, and the controller may determine a length of the document according to the presence of the document.

The controller may determine document size according to the width and length of the document.

In accordance with embodiments and utilities of the present general inventive concept, in a control method of an image reading apparatus including a cover, the cover being provided with a mark pattern having a preset length to sense a width of a document, the control method includes irradiating light to a region where the mark pattern is formed, producing an image upon receiving the light reflected from the region where the mark pattern is formed, and determining the width of the document according to a length of a region of the produced image where a constant pixel value is sensed.

In the irradiation of light, the region where the mark pattern is formed may correspond to a region of the cover corresponding to a front end of the document, and the mark pattern may include two marks having different colors alternately arranged at a preset interval in a main-scanning direction.

The control method may further include determining a length of the document by sensing a presence of the document using a document sensor arranged below a document platen on which the document is placed.

The control method may further include determining document size according to the width and length of the document.

In accordance with utilities and embodiments of the present general inventive concept, in a control method of an image reading apparatus including a cover, the cover being provided with a mark pattern having a preset length to sense a width of a document, the control method includes determining whether or not the cover is closed, irradiating light from a light source to a region where the mark pattern is formed when the cover is closed, producing an image upon receiving the light reflected from the region where the mark pattern is formed, and determining the width of the document according to a length of a region of the produced image where a constant pixel value is sensed.

In the irradiation of light, the region where the mark pattern is formed may correspond to a region of the cover corresponding to a front end of the document, and the mark pattern may include two marks having different colors alternately arranged at a preset interval in a main-scanning direction.

The irradiation of light to the region where the mark pattern is formed may include moving the light source to a position corresponding to the region where the mark pattern is formed when the cover is closed, and turning on the light source when the light source is moved to the position.

The control method may further include determining a length of the document by sensing a presence of the document using a document sensor arranged below a document platen on which the document is placed.

The control method may further include determining document size according to the width and length of the document.

In accordance with embodiments and utilities of the present general inventive concept, an image reading apparatus includes a cover formed with a mark pattern; a scanning device to read the mark pattern of the cover; and a controller to determine a size of a document according to the read mark pattern.

The scanning device may read a portion of the document. The controller may determine the size of the document according to the read portion of the document.

The image reading apparatus may further include a document sensor to detect an existence of the document with respect to the cover. The controller may determine the size of the document according to the detected existence of the document. The document sensor may be stationary.

The scanning device may include a light source which is movable with respect to the cover. The scanning device may read a first portion of the mark pattern which is overlapped by the document and a second portion of the mark pattern which is not overlapped by the document. The controller may determine the size of the document according to the first and second portions of the mark pattern.

In accordance with embodiments and utilities of the present general inventive concept, an image reading apparatus includes a cover formed with a mark pattern; a scanning device to scan a first side of a document and a portion of the mark pattern; a document sensor to detect a second side of the document; and a controller to determine a size of the document according to the first side of the document, the scanned portion of the mark pattern, and the second side of the document.

The controller may determine a paper size group according to the second side of the document. The controller may further determine one of a plurality of sizes of the determined paper size group according to the first side of the document and the scanned portion of the mark pattern.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating an external appearance of an image reading apparatus according to an embodiment of the present general inventive concept;

FIG. 2 is a sectional view of the image reading apparatus when viewed in a sub-scanning direction according to an embodiment;

FIG. 3 is a sectional view of the image reading apparatus when viewed in a main-scanning direction according to an embodiment;

FIG. 4 is a view illustrating a mark pattern provided at a document push plate of the image reading apparatus and a document width corresponding to the mark pattern according to an embodiment;

FIGS. 5A and 6A are views illustrating determination of a first width of a first document positioned in a first orientation in the image reading apparatus according to an embodiment;

FIGS. 5B and 6B are views illustrating determination of a first width of a first document positioned in a second orientation in the image reading apparatus according to an embodiment;

FIGS. 7 and 8 are views illustrating determination of a second width of a second document in the image reading apparatus according to an embodiment;

FIG. 9 is a schematic control block diagram of the image reading apparatus according to an embodiment;

FIG. 10 is a control flow chart illustrating a control method of the image reading apparatus according to an embodiment;

FIG. 11 is a control flow chart illustrating an alternative control method of the image reading apparatus according to an embodiment; and

FIG. 12 is a control flow chart illustrating another alternative control method of the image reading apparatus according to an embodiment.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

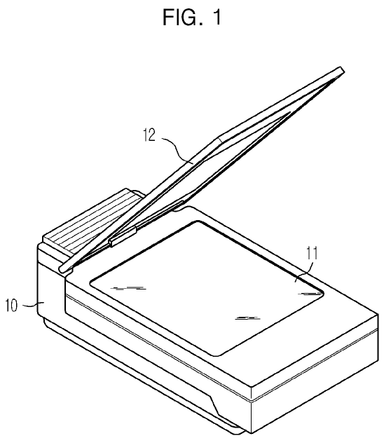

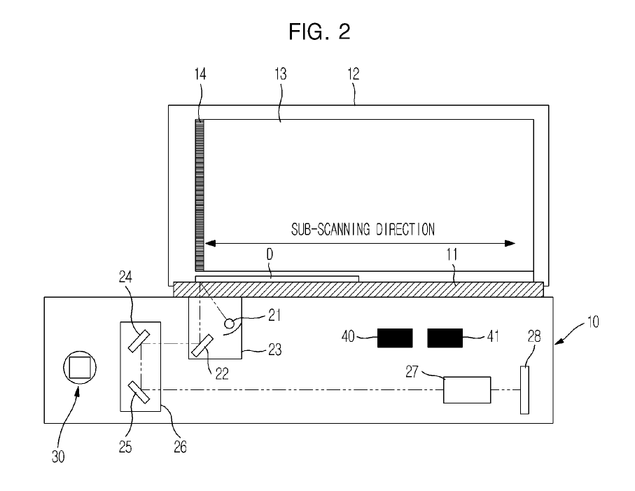

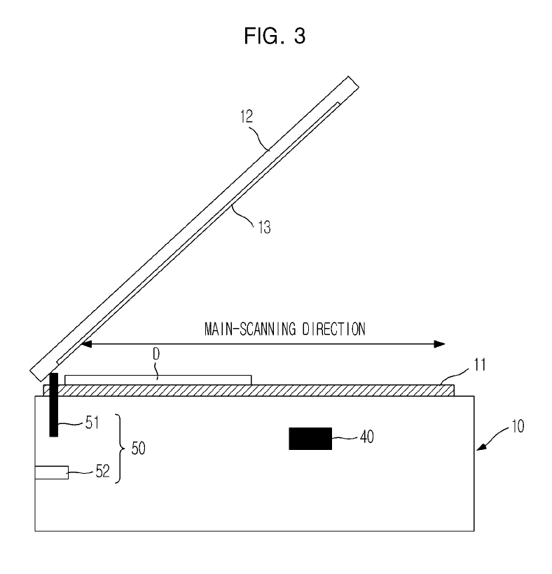

FIG. 1 is a perspective view illustrating an external appearance of an image reading apparatus according to an embodiment of the present general inventive concept, FIG. 2 is a sectional view of the image reading apparatus when viewed in a sub-scanning direction (i.e., parallel to a hinge of a cover of the image reading apparatus) according to an embodiment, and FIG. 3 is a sectional view of the image reading apparatus when viewed in a main-scanning direction (i.e., orthogonal to the hinge of the cover of the image reading apparatus) according to an embodiment.

As illustrated in FIG. 1, the image reading apparatus according to the embodiment of the present general inventive concept includes a body 10, a document platen 11, upon which a document D is placed, installed on an upper surface of the body 10, and a platen cover 12 coupled to the body 10 by a hinge so as to be opened away or closed to the document platen 11. The platen cover 12 is configured to cover the document platen 11 in a closed state thereof. In the plane of the document platen, the “sub-scanning direction” is defined herein as the direction parallel to the hinge of the cover 12, and the “main-scanning direction” is defined herein as the direction orthogonal to the hinge of the cover 12, i.e., the direction proceeding between the hinge and the open end of the cover 12.

As illustrated in FIGS. 2 and 3, the body 10 of the image reading apparatus according to the embodiment includes a cover sensing device 50, a scanning device 20, and a drive motor 30.

The cover sensing device 50 outputs a signal when the cover 12 is opened by a predetermined angle or more (for example, 80 degrees or more). The cover sensing device 50 also outputs a signal at a time when the cover 12, which has been opened by the predetermined angle or more (for example, 80 degrees or more), is closed. The cover sensing device 50 includes a photo sensor 52 and a sensor flag 51. The sensor flag 51 is moved upward or downward by opening or closing operation of the cover 12. The sensor flag 51 is gradually pressed down as the cover 12 is closed, and is released when the cover 12 is opened. The upward or downward movement of the sensor flag 51 selectively intercepts light to be transmitted to the photo sensor 52, allowing the photo sensor 52 to sense closing of the cover 12. As will be described hereinafter, document size may be determined by sensing the width and length of the document D placed on the document platen 11 when the cover 12 is closed.

The scanning device 20 is provided at a rear surface of the document platen 11. The scanning device 20 includes a light source 21 to irradiate light to the document D, a plurality of mirrors 22, 24 and 25 to reflect the light reflected from the document D, a lens 27 to condense the light reflected from the mirrors 22, 24 and 25, and an image sensor 28 to convert the light condensed by the lens 27 into electrical signals. Accordingly, the light reflected from the document D is sequentially reflected by first, second and third mirrors 22, 24 and 25 and then, is condensed to the lens 27, thereby being finally introduced into the image sensor 28.

The light source 21 and the first mirror 22 are mounted on a first optical carrier 23, and the second mirror 24 and the third mirror 25 are mounted on a second optical carrier 26. The first optical carrier 23 and the second optical carrier 26 are movable with respect to the document platen 11 in a sub-scanning direction. Specifically, the first optical carrier 23 and the second optical carrier 26 are reciprocally moved in the sub-scanning direction by the drive motor 30.

The image sensor 28 is fixed at a preset position. For reference, all constituent elements of the scanning device 20 may be integrated in a module to be reciprocally moved with respect to the document platen 11 in the sub-scanning direction.

The light source 21 may be a lamp to irradiate light to the document D.

The image sensor 28 may be a Charge Coupled Device (CCD) or Contact Image Sensor (CIS) to convert optical signals obtained via document scanning into electrical signals. The image sensor 28 is installed parallel to the document platen 11 and is longitudinally arranged in a main-scanning direction. During document reading, the image sensor 28 receives light when the light irradiated from the light source 21 is reflected by the document D, and outputs electrical signals depending on a received quantity of light. Specifically, when the light irradiated from the light source 21 is reflected by the document D, the reflected light is again reflected by the first mirror 22 to the third mirror 25 and then, is condensed by the lens 27 to thereby be transmitted to the image sensor 28. The first optical carrier 23 and the second optical carrier 26 are moved in the sub-scanning direction during document reading, allowing the image sensor 28 to produce an image data corresponding to an image of the document D. The image data produced by the image sensor 28 is transmitted to a controller 60 that will be described hereinafter. The controller 60 recognizes the image data as an image to be formed.

A document sensor 40 is provided to sense the presence of the document D at an installed position thereof, to determine the length of the document D placed on the document platen 11. As described herein, the “length of the document D” refers to the linear dimension of the document D in the sub-scanning direction, and the “width of the document D” refers to the linear dimension of the document D in the main-scanning direction. The document sensor 40 includes a reflection type photo sensor having a light emitting element to irradiate light toward the document D through the document platen 11 and a light receiving element to receive the light reflected from the document D.

When the document D is present at a position opposite to the document sensor 40 with respect to the document platen 11, the light emitted from the light emitting element is reflected by the document D, so that the light receiving element receives most the reflected light. However, when the document D is not present at the position opposite to the document sensor 40 with respect to the document platen 11, the light emitted from the light emitting element is reflected in a direction away from the light receiving element, so that the light receiving element receives a reduced quantity of light. Accordingly, the presence of the document D may be sensed based on a difference in the received quantity of light. Although FIG. 2 illustrates two document sensors 40 and 41, three or more sensors may be arranged below the document platen 11 at positions corresponding to different document lengths. Accordingly, a greater precision in determining document length can be achieved by using additional document sensors. The document sensors 40, 41 may be stationary with respect to the document D and the document platen 11.

In the meantime, the platen cover 12 of the image reading apparatus according to the embodiment includes a document push plate 13 to push the document D placed on the document platen 11. The document push plate 13 is formed of a white sheet to process a white margin of the document D during document reading. The document push plate 13 is provided with a mark pattern 14. The mark pattern 14 consists of a plurality of white bars and black bars which are alternately printed in the main-scanning direction.

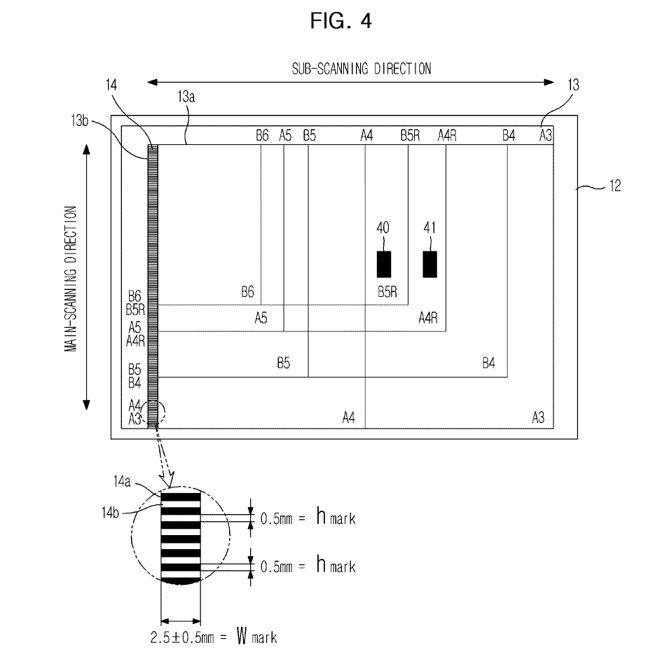

FIG. 4 is a view illustrating the mark pattern 14 provided at the document push plate 13 of the image reading apparatus and a document width corresponding to the mark pattern 14 according to an embodiment.

As illustrated in FIG. 4, the document platen 11 is marked at an outer periphery thereof with document size labels that represent document sizes, such as B6, A5, B5, A4, B5R, A4R, B4 and A3 sizes. This allows a user to accurately place the document D at a position suitable for the size of the document D with reference to the document size labels. FIG. 4 illustrates an example of placing documents of B6, A5, B5, A4, B5R, A4R, B4 and A3 sizes on the document platen 11.

In an operation to sense the size of the document D, the width of the document D is sensed using the mark pattern 14 that is formed at the document push plate 13 to correspond to the document width, and the length of the document D is sensed using the document sensor 40 that is arranged on a per document length basis.

If the user places the document D on the document platen 11 with reference to the document size labels, the document sensor 40 senses the presence of the document D, thus determining the length of the document D. In one example, assuming that the first document sensor 40 is installed at a position corresponding to a B5R size and the second document sensor 41 is installed at a position corresponding to an A4R size, if the first document sensor 40 senses “No Document” and the second sensor 41 senses “No Document”, it is determined that the length of the document D corresponds to any one of B6, A5, B5 and A4 sizes. If the first document sensor 40 senses “Document Ready” and the second document sensor 41 senses “No Document”, it is determined that the length of the document D corresponds to a B5R size. Also, if the first document sensor 40 senses “Document Ready” and the second document sensor 41 senses “Document Ready”, it is determined that the length of the document corresponds to any one of A4R, B4 and A3 sizes.

In the meantime, the mark pattern 14, which is formed on the document push plate 13 to sense the width of the document D placed on the document platen 11, is printed in the main-scanning direction on a region of the document push plate 13 corresponding to a front end of the document D (i.e., the edge of the document D that is closest to the mark pattern 14). For example, the mark pattern 14 includes black bars 14a and white bars 14b (or gray bars), which are printed to have equal preset widths wₘₐᵣₖ (for example, 2.5±0.5 mm) and equal preset heights hₘₐᵣₖ (for example, 0.5 mm) within a scan masking region range (for example, 4 mm or less). More specifically, the mark pattern 14 is configured such that the plurality of black bars 14a is printed at the same interval within a preset length range. In one example, the mark pattern 14 may be promptly scanned only by a width of about 3 mm from the front end of the document D.

As illustrated in FIG. 4, the document push plate 13 includes a reference line 13a corresponding to a side of the document D in the sub-scanning direction and a reference line 13b corresponding to a side of the document D in the main-scanning direction, adjacent to the mark pattern 14.

The first optical carrier 23 of the scanning device 20 is located at a place corresponding to the mark pattern 14 of the document push plate 13 during document size sensing. The place corresponding to the mark pattern 14 may be a home position of the first optical carrier 23. Accordingly, since it is unnecessary to move the first optical carrier 23 if the place corresponding to the mark pattern 14 of the document push plate 13 is the home position, a document reading operation may promptly begin as soon as the document size is determined, resulting in a reduced image reading time.

An image of the mark pattern 14 formed at the document push plate 13 is produced during document size sensing. The produced image is analyzed to determine a time when a repeated pixel value of 0 or 256 changes to the other pixel value (for example, a time when a pixel value of 0 (black) changes to a pixel value of 256 (white)). The length of an image region where the same pixel value is sensed prior to the change time is determined as the width of the document D. Specifically, since some bars of the mark pattern 14 are hidden by the width of the document D when the document D is placed on the document platen 11, the same pixel value of 256 is sensed in the hidden region. Then, after the mark pattern 14 is exposed from behind the width of the document D, the black bars 14a and the white bars 14b begin to be alternately revealed so that the pixel value changes in the sequence of 0→256→0→256→0→256→0→256→ . . . . In this case, the length of the region where the same pixel value is sensed is determined as the width of the document D.

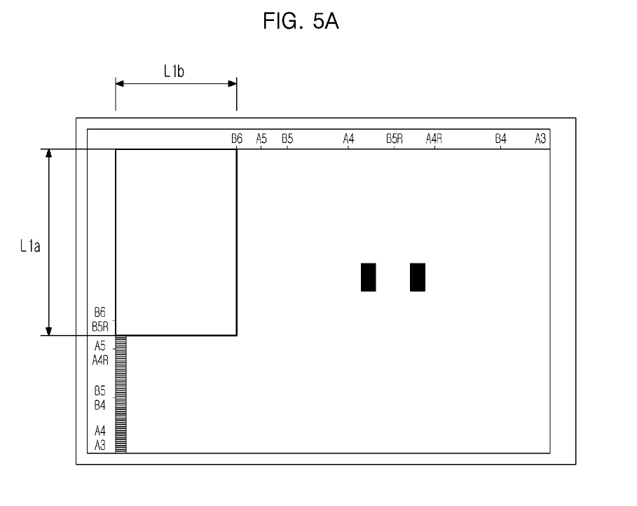

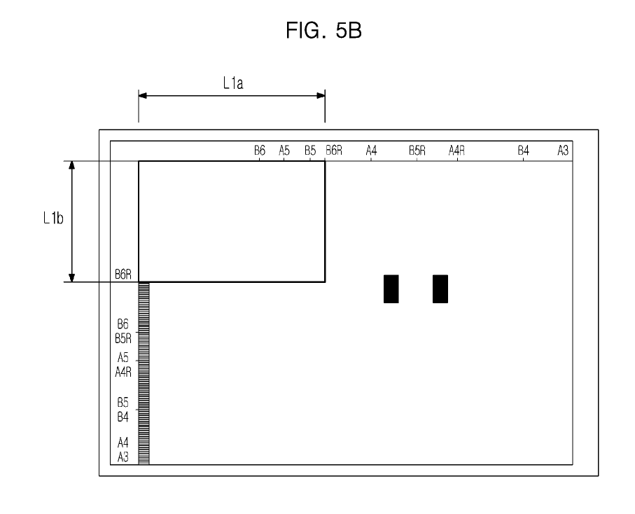

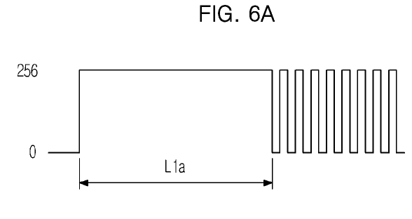

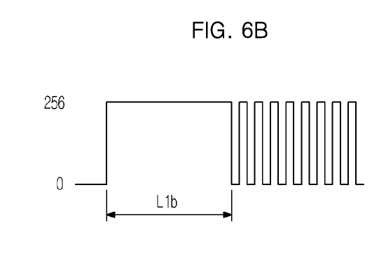

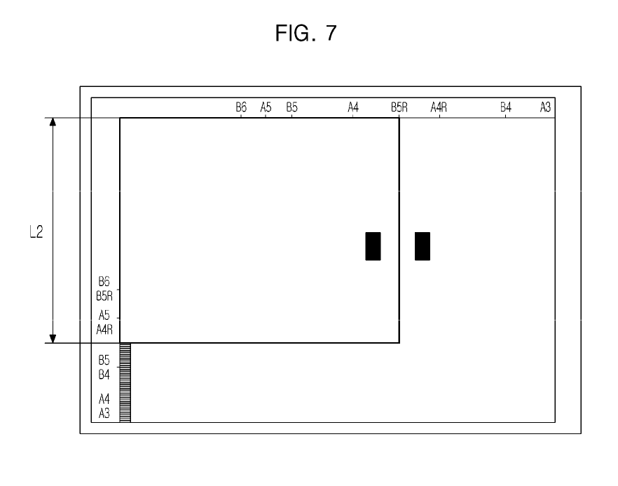

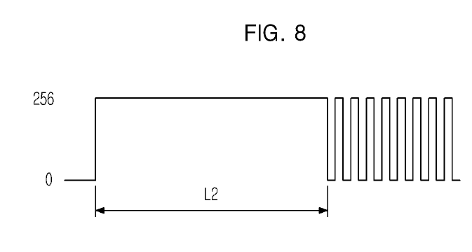

FIGS. 5A and 6A are views illustrating determination of a first width L1a of a first document when oriented in a first orientation in the image reading apparatus according to an embodiment, FIGS. 5B and 6B are views illustrating determination of a width L1b of the first document when oriented in a second orientation in the image reading apparatus according to an embodiment, and FIGS. 7 and 8 are views illustrating determination of a second width L2 of a second document in the image reading apparatus according to an embodiment.

Referring to FIGS. 5A and 6A, an image of a region, where the mark pattern 14 is formed, is produced and analyzed in the case of a document oriented according to a first orientation and having a length L1b equal to that of a B6 size and a width L1a greater than that of the B6 size. In this case, a constant white pixel value of 256 is sensed in the range of the document width L1a and then, the pixel value changes in the sequence of 0→256→0→256→0→256→0→256→ . . . following the constant pixel value corresponding to the document width L1a. Accordingly, it may be determined that the width of the document D is equal to the length of a region where the constant pixel value of 256 is sensed.

Referring to FIGS. 5B and 6B, an image of a region, where the mark pattern 14 is formed, is produced and analyzed in the case of the same document oriented according to a second orientation and having a length L1a greater than that of a B6R size and a width L1b equal to that of the B6R size. In this case, a constant white pixel value of 256 is sensed in the range of the document width L1b and then, the pixel value changes in the sequence of 0→256→0→256→0→256→0→256→ . . . following the constant pixel value corresponding to the document width L1b. Accordingly, it may be determined that the width of the document D is equal to the length of a region where the constant pixel value of 256 is sensed.

Referring to FIGS. 7 and 8, an image of a region, where the mark pattern 14 is formed, is produced and analyzed in the case of a document having a length equal to that of a B5R size and a width L2 greater than that of the B5R size (L2>L1). In this case, a constant white pixel value of 256 is sensed in the range of the document width L2 and then, the pixel value changes in the sequence of 0→256→0→256→0→256→0→256→ . . . following the constant pixel value corresponding to the document width L2. Accordingly, it may be determined that the width of the document D is equal to the length of a region where the constant pixel value of 256 is sensed.

Document size may be determined based on the length and width of the document D sensed as described above. In the case where only standard size documents are usable, the most similar standard document size may be determined from the sensed length and width of the document D (for example, an A5 size is determined in the case of FIG. 5A and a B4 size is determined in the case of FIG. 7). On the other hand, in the case where non-standard size documents are usable, document size may be directly determined from the sensed length and width of the document D.

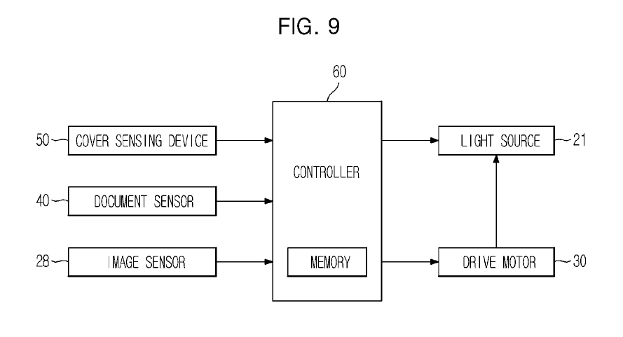

FIG. 9 is a schematic control block diagram of the image reading apparatus according to an embodiment.

As illustrated in FIG. 9, the image reading apparatus according to an embodiment of the present general inventive concept includes the controller 60 to perform general control operations.

The controller 60 controls operation of the cover sensing device 50, scanning device 20 and drive motor 30.

The controller 60 senses operation of the cover sensing device 50 thus recognizing opening or closing of the cover 12.

The controller 60 automatically determines document size by sensing the width and length of the document D based on outputs from the image sensor 28 of the scanning device 20 and outputs from the document sensor 40. More specifically, with reference to the outputs of the image sensor 28, the controller 60 determines the width of the document D that is equal to the length of the image region where the same pixel value is sensed. Also, with reference to the outputs of the document sensor 40, the controller 60 determines the length of the document D according to whether or not the document D is present at the installed place of the document sensor 40.

In this case, the controller 60 determines closing of the cover 12 using the cover sensing device 50. If closing of the cover 12 is sensed, the controller 60 controls the drive motor 30 to move the first optical carrier 23 and the second optical carrier 26 in the sub-scanning direction, allowing the first optical carrier 23 having the light source 21 to be automatically moved to a position corresponding to a region of the mark pattern 14 of the document push plate 13. Thereafter, the controller 60 produces an image of the region of the mark pattern 14 and determines the width of the document D according to the length of the image region where the same pixel value is sensed. After determining the width of the document D, the controller 60 returns the first optical carrier 23 to a home position. In this case, as described above, if the position corresponding to the region where the mark pattern 14 is formed is equal to the home position, it is unnecessary to move the first optical carrier 23.

Hereinafter, a method of determining document size will be described in detail.

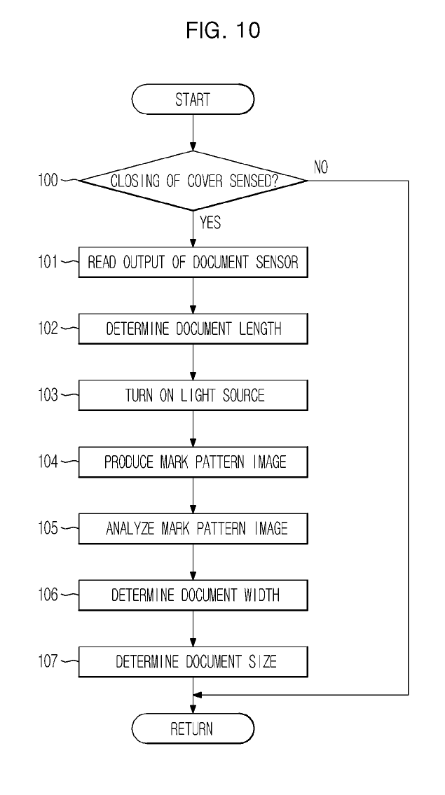

FIG. 10 is a control flow chart illustrating a control method of the image reading apparatus according to an embodiment.

Referring to FIG. 10, if the user places a document on the document platen 11 and closes the cover 12 to begin a document reading operation, the controller 60 recognizes an operational mode of the cover sensing device 50, thus determining whether or not closing of the cover 12 is sensed at operation 100.

If closing of the cover 12 is sensed, the controller 60 reads outputs of the document sensors 40 and 41 at operation 101.

The controller 60 determines the length of the document (in the sub-scanning direction) by reading the outputs of the document sensors 40 and 41 at operation 102. As illustrated in FIG. 4, assuming that the first document sensor 40 is installed at a position corresponding to a B5R size and the second document sensor 41 is installed at a position corresponding to an A4R size, of the first document sensor 40 senses “No Document” and the second document sensor 41 senses “No Document”, the controller 60 determines that the length of the document corresponds to any one of B6, A5, B5 and A4 sizes. If the first document sensor 40 senses “Document Ready” and the second sensor 41 senses “No Document”, the controller 60 determines that the length of the document corresponds to a B5R size. Also, if the first document sensor 40 senses “Document Ready” and the second sensor 41 senses “Document Ready”, the controller 60 determines that the length of the document corresponds to any one of A4R, B4 and A3 sizes.

Simultaneously with determination of the document length, the controller 60 controls the drive motor 30 to move the first optical carrier 23 having the light source 21 of the scanning device 20 to a position corresponding to a region where the mark pattern 14 is formed. In this case, if an initial position of the first optical carrier 23 is equal to the position corresponding to the region where the mark pattern 14 is formed, it is unnecessary to move the first optical carrier 23.

After moving the first optical carrier 23, the controller 60 turns on the light source 21 to scan the region where the mark pattern 14 is formed at operation 103. The light emitted from the light source 21 is irradiated to the region where the mark pattern 14 is formed, and the light reflected from the region is introduced into the image sensor 28 by way of the plurality of mirrors 22, 24 and 25 and the lens 27.

After turning on the light source 21, the controller 60 controls the image sensor 28 to produce an image of the region where the mark pattern 14 is formed at operation 104.

After producing the mark pattern image, the controller 60 analyzes the mark pattern image at operation 105. Analyzing the mark pattern image entails analyzing pixel values of the mark pattern image, thus dividing the mark pattern image into a region where the same pixel value is sensed and the remaining region where pixel values alternate. A specific region of the mark pattern is hidden by the document placed on the document platen 11, thus preventing the scanning device 20 from sensing the mark pattern 14. Therefore, the controller 60 may recognize the remaining region of the mark pattern that is not hidden by the document.

The controller 60 determines the length of the region where the same pixel value is sensed as the width of the document (in the main-scanning direction) based on analyzed results of the mark pattern image at operation 106.

The controller 60 finally determines document size according to the length and width of the document determined in operation modes 102 and 106 at operation 107.

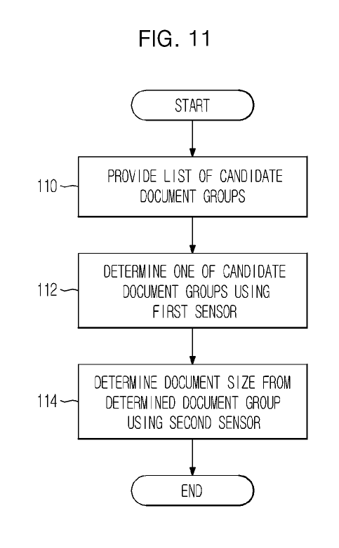

FIG. 11 is a control flow chart illustrating an alternative control method of the image reading apparatus according to an embodiment.

Referring to FIG. 11, if the user places a document on the document platen 11 and closes the cover 12 to begin a document reading operation, at operation 110, the controller 60 provides a list of candidate document groups, one of which being a group to which the document belongs. Each of the candidate document groups includes a plurality of document sizes.

At operation 112, the controller 60 uses the output of a first document sensor to determine which of the candidate document groups is the correct group to which the document belongs. Accordingly, based on the determined document group, the document has a size that matches one of the plurality of document sizes contained in the determined document group.

At operation 114, the controller 60 uses the output of a second document sensor to determine which of the plurality of document sizes is the correct size to match the size of the document.

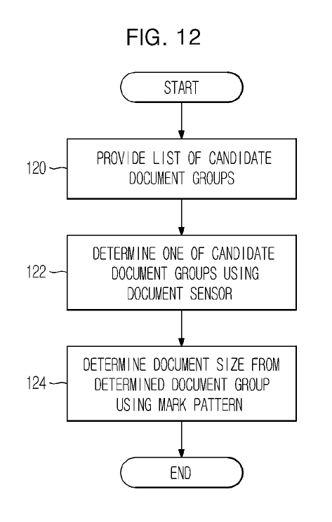

Referring to FIG. 12, if the user places a document on the document platen 11 and closes the cover 12 to begin a document reading operation, at operation 120, the controller 60 provides a list of candidate document groups, one of which being a group to which the document belongs. Each of the candidate document groups includes a plurality of document sizes.

At operation 122, the controller 60 uses the output of a document sensor to determine which of the candidate document groups is the correct group to which the document belongs. Accordingly, based on the determined document group, the document has a size that matches one of the plurality of document sizes contained in the determined document group.

At operation 124, the controller 60 uses the mark pattern to determine which of the plurality of document sizes is the correct size to match the size of the document.

In an embodiment, a control method of the image reading apparatus may be implemented through the use of a computer-readable medium. For example, the computer-readable medium may be implemented in a computing device, such as a personal computer, which is in communication with the controller 60. The controller 60 may provide information to the computing device, including, for example, an output of the cover sensing device 50; outputs of the document sensors 40 and 41; and/or information relating to the mark pattern image produced by the image sensor 28. The computer-readable medium may store software containing instructions which, when executed by a computer, use the provided information to determine a document length, a document width, and a document size, similarly as described above with respect to FIG. 10. In this manner, the computer-readable medium can be used to determine a size of a document using the image reading apparatus according to an embodiment.

As apparent from the above description, in an image reading apparatus according to the embodiments of the present general inventive concept, a mark pattern is provided to determine the width of a document, enabling elimination of sensors to sense the document width. This enables accurate determination of document size with reduced manufacturing costs of the image reading apparatus.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image reading apparatus comprising:
a cover provided with a mark pattern having a preset length to sense a width of a document;
a scanning device to irradiate light to a region where the mark pattern is formed and to produce an image upon receiving the light reflected from the region where the mark pattern is formed; and
a controller to determine the width of the document based on a length of a region of the produced image where a constant pixel value is sensed.

2. The image reading apparatus according to claim 1, wherein the mark pattern includes two marks having different colors alternately arranged at a preset interval in a main-scanning direction.

3. The image reading apparatus according to claim 2, wherein the mark pattern is formed at a document push plate provided to push the document when the cover is closed.

4. The image reading apparatus according to claim 3, wherein the mark pattern is formed at a region of the document push plate corresponding to a front end of the document.

5. The image reading apparatus according to claim 1, further comprising a cover sensing device to sense closing of the cover,
wherein the controller turns on the scanning device to produce the image when closing of the cover is sensed by the cover sensing device.

6. The image reading apparatus according to claim 1, further comprising a document sensor arranged below a document platen, on which the document is placed, to sense a presence of the document,
wherein the controller determines a length of the document according to the presence of the document.

7. The image reading apparatus according to claim 6, wherein the controller determines a document size according to the width and length of the document.

8. An image reading apparatus comprising:
a cover provided with a mark pattern having a preset length to sense a width of a document;
a scanning device to irradiate light to a region where the mark pattern is formed and to produce an image upon receiving the light reflected from the region where the mark pattern is formed;
a cover sensing device to sense closing of the cover; and
a controller to allow the image to be produced when closing of the cover is sensed by the cover sensing device, and to determine the width of the document according to a length of a region of the produced image where a constant pixel value is sensed.

9. The image reading apparatus according to claim 8, wherein the mark pattern includes two marks having different colors alternately arranged at a preset interval in a main-scanning direction in a region of the cover corresponding to a front end of the document.

10. The image reading apparatus according to claim 9, further comprising a drive motor to move a light source of the scanning device in a sub-scanning direction to irradiate the light to the region,
wherein the drive motor moves the light source to a position corresponding to the region where the mark pattern is formed when the cover is closed, to allow the image to be produced when the cover is closed.

11. The image reading apparatus according to claim 9, further comprising a document sensor arranged below a document platen, on which the document is placed, to sense a presence of the document,
wherein the controller determines a length of the document according to the presence of the document.

12. The image reading apparatus according to claim 11, wherein the controller determines document size according to the width and length of the document.

13. A control method of an image reading apparatus including a cover, the cover being provided with a mark pattern having a preset length to sense a width of a document, the control method comprising:
irradiating light to a region where the mark pattern is formed;
producing an image upon receiving the light reflected from the region where the mark pattern is formed; and
determining the width of the document according to a length of a region of the produced image where a constant pixel value is sensed.

14. The control method according to claim 13, wherein, in the irradiation of light, the region where the mark pattern is formed corresponds to a region of the cover corresponding to a front end of the document, and the mark pattern includes two marks having different colors alternately arranged at a preset interval in a main-scanning direction.

15. The control method according to claim 14, further comprising determining a length of the document by sensing a presence of the document using a document sensor arranged below a document platen on which the document is placed.

16. The control method according to claim 15, further comprising determining document size according to the width and length of the document.

17. A control method of an image reading apparatus including a cover, the cover being provided with a mark pattern having a preset length to sense a width of a document, the control method comprising:
determining whether or not the cover is closed;
irradiating light from a light source to a region where the mark pattern is formed when the cover is closed;
producing an image upon receiving the light reflected from the region where the mark pattern is formed; and
determining the width of the document according to a length of a region of the produced image where a constant pixel value is sensed.

18. The control method according to claim 17, wherein, in the irradiation of light, the region where the mark pattern is formed corresponds to a region of the cover corresponding to a front end of the document, and the mark pattern includes two marks having different colors alternately arranged at a preset interval in a main-scanning direction.

19. The control method according to claim 18, wherein the irradiation of light to the region where the mark pattern is formed includes moving the light source to a position corresponding to the region where the mark pattern is formed when the cover is closed, and turning on the light source when the light source is moved to the position.

20. The control method according to claim 19, further comprising determining a length of the document by sensing a presence of the document using a document sensor arranged below a document platen on which the document is placed.

21. The control method according to claim 20, further comprising determining document size according to the width and length of the document.

22. An image reading apparatus comprising:
a cover formed with a mark pattern;
a scanning device to read the mark pattern of the cover; and
a controller to determine a size of a document according to the read mark pattern.

23. The image reading apparatus according to claim 22, wherein the scanning device reads a portion of the document and the controller determines the size of the document according to the read portion of the document.

24. The image reading apparatus according to claim 22, further comprising a document sensor to detect an existence of the document with respect to the cover, wherein the controller determines the size of the document according to the detected existence of the document.

25. The image reading apparatus according to claim 24, wherein the document sensor is stationary.

26. The image reading apparatus according to claim 22, wherein the scanning device includes a light source which is movable with respect to the cover.

27. The image reading apparatus according to claim 22, wherein the scanning device reads a first portion of the mark pattern which is overlapped by the document and a second portion of the mark pattern which is not overlapped by the document, and the controller determines the size of the document according to the first and second portions of the mark pattern.

28. An image forming apparatus comprising:
a cover formed with a mark pattern;
a scanning device to scan a first side of a document and a portion of the mark pattern;
a document sensor to detect a second side of the document; and
a controller to determine a size of the document according to the first side of the document, the scanned portion of the mark pattern, and the second side of the document.

29. The image forming apparatus of claim 28, wherein the controller determines a paper size group according to the second side of the document and determines one of a plurality of sizes of the determined paper size group according to the first side of the document and the scanned portion of the mark pattern.
